(19) United States
(12) Patent Application Publication
(10) Pub. No.: US 2021/0319466 A1
(43) Pub. Date: Oct. 14, 2021

(54) Hospitality Plus

(71) Applicant: Syed Abraham Ahmed, Houston, TX (US)

(72) Inventor: Syed Abraham Ahmed, Houston, TX (US)

(21) Appl. No.: 17/359,263

(22) Filed: Jun. 25, 2021

(51) Int. Cl. G06Q 30/02

(52) U.S. Cl. CPC G06Q 30/0205; G06Q 10/02

(57) ABSTRACT

The Hospitality Plus app is a website/IOS/Android app for all hospitality needs it is a network for builders, investors, technicians, contractors, providers, hotel management, valet, chiefs, food, and anything hospitality-related all in one place. Divided into sectors such as but not limited to government, hotel, medical, student-housing, apartment, hotel-management, extended-stay, and residential. Marketing/advertising on the app by having clients place bids on builders/contractors/technicians/services/hospitality products and anything in the hospitality industry. The app is to broker the deals taking a percentage of the sale. Clients can book hotels through hotel partners, have hospitality companies' post-employment opportunities, networking hospitality events, a premium subscription; promote products; List industry services and vendors, pay for business placement in listing management Create customer segmentation with marketing, company directories, social media, networking, members profiles, hospitality services/products, network-events, paid-listing management, industry-segmentation, request-a-quote, in one place for anything related to hospitality.

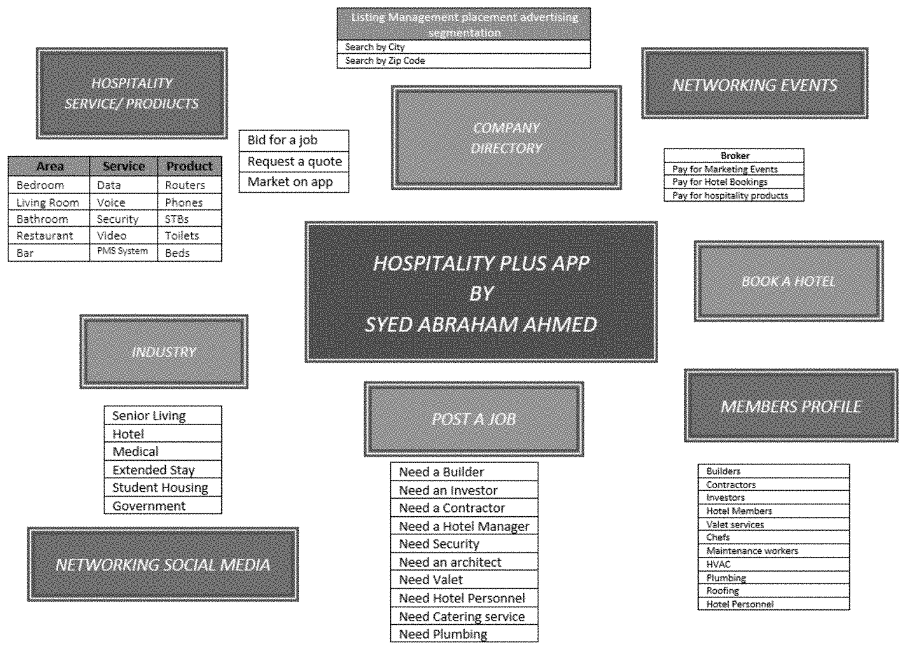

The Hospitality Plus app is a website/IOS/Android app for all hospitality needs it is a network for builders, investors, technicians, contractors, providers, hotel management, valet, chiefs, food, and anything hospitality related all in one place. Divided into sectors such as but not limited to government, hotel, medical, student housing, apartment, hotel management, extended stay, and residential. Marketing/advertising on the app by having clients place bids on builders/contractors/technicians/services/hospitality products and anything in the hospitality industry. The app is to broker the deals taking a percentage of the sale. Clients can book hotels through hotel partners, have hospitality companies' post-employment opportunities, networking hospitality events, a premium subscription; promote products; List of industry services and vendors, pay for business placement in listing management. For example, pay this amount to be placed first in businesses for contractors in the area, segmented by city/zip/state/country. Create customer segmentation with marketing in the app, company directories, social media, networking, members profiles, hospitality services/hospitality products, network events, paid listing management, industry segmentation, request a quote, all in one place for anything related to hospitality services. I am patenting that I am the only one who can bring all hospitality products, services, networking, social media, listing management, requesting a quote, placing a bid, company directory, job posting, members profiles in one area. The usage of all hospitality companies, services, and products, and members profiles in one place either on an application or website.

I Syed Abraham Ahmed is the inventor and creator of the design of the app, and all ideas inside of the app. The app will be something you can download on a phone or tablet, and use from the IOS/Android store if you are related to the hospitality industry you can create a profile and utilize the benefits of the app or go on the website that is to be created after the patent of the idea and design of the app.

1. The Hospitality Plus app is designed that the home page is interfaced with square boxed shaped areas to click on that directs you to segmented portions of the app.
1. The boxes are:
Company directory
Listing management with placement advertising segmentation
1. Search by City
2. Search by Zip code
3. Search by State
4. Search by industry
a. Senior living
b. Hotel
c. Extended stay
d. Student housing
e. Government
5. Search by career field
6. Search by service
7. Search by product
8. Search by area of home
a. Bedroom
b. Office
c. Bathroom
d. Restaurant
e. Bar
f. Dining area
g. Leasing area
h. Pool area
i. Gym area
j. Any area in a hospitality location
Network events
Book a hotel
ii. Hotel listings based on zip code with a map showing the hotels in the area that can be segmented based on listing management in paid advertising of hotel
Member's profile
iii. Builders
iv. Contractors
v. Investors
vi. Hotel members
vii. Valet service
viii. Chefs
ix. Maintenance workers
x. HVAC technician
xi. Plumbing
xii. Roofing
xiii. Construction worker
xiv. Hotel personnel
xv. General laborer
Post a job
xvi. Request a job
xvii. Request a quote
xviii. Find a builder
xix. Find a investor
xx. Find a contractor
xxi. Find a hotel manager
xxii. Find security
xxiii. Find an architect
xxiv. Find a valet service
xxv. Find a hotel personnel
xxvi. Find catering service
xxvii. Find plumbing
xxviii. Find roofing
xxix. Find construction
xxx. Find HVAC
xxxi. Find valet
Networking social media
xxxii. Post on a timeline regarding service or hospitality related information
xxxiii. Post article
xxxiv. Post link
xxxv. Post jobs
xxxvi. Post writing
xxxvii. Post pictures
Industry
xxxviii. Senior living
xxxix. Hotel
xl. Medical
xli. Extended stay
xlii. Student housing
xliii. Government
Hospitality service
xliv. Data
xlv. Voice
xlvi. Security
xlvii. PMS system
xlviii. Video subscription
xlix. Maintenance
l. cooking
li. construction
lii. management
liii. funding
liv. valet
lv. catering
Hospitality products
lvi. Routers
lvii. Phones
lviii. Set top boxes
lix. Toilets
lx. Beds
lxi. Any type of hospitality product sold in the hospitality industry
Broker
lxii. Pay for marketing
lxiii. Pay for hotel booking
lxiv. Pay for hospitality product
lxv. Market on app
lxvi.
2. All categories have sub categories that all interlink to each other that allows for effortless flow in the app and connection of hospitality people and companies and services and products while marketing, selling, bidding, and selling products/services.
